(19) United States
(12) Patent Application Publication
(10) Pub. No.: US 2014/0082547 A1
(43) Pub. Date: Mar. 20, 2014

(54) THREE-DIMENSIONAL DESKTOP SWITCHING SYSTEM ON HANDHELD APPARATUS AND METHOD THEREOF

(71) Applicants: INVENTEC (PUDONG) TECHNOLOGY CORPORATION, (US); INVENTEC CORPORATION, Taipei (TW)

(72) Inventor: Ke DING, Shanghai (CN)

(73) Assignees: INVENTEC CORPORATION, Taipei (TW); INVENTEC (PUDONG) TECHNOLOGY CORPORATION, Shanghai (CN)

(21) Appl. No.: 13/804,251

(22) Filed: Mar. 14, 2013

(30) Foreign Application Priority Data
Sep. 18, 2012 (CN) 201210348036.X

(51) Int. Cl. G06F 3/0481

(52) U.S. Cl. CPC G06F 3/04815
USPC 715/778

(57) ABSTRACT

For a three-dimensional desktop switching system on a handheld apparatus and a method thereof, a selected program desktop and a selected designated desktop are switched fast through a program desktop selection instruction and a designated desktop selection instruction, so as to reduce the number of times of performing operations and the number of times of performing loading and update during desktop switching, thereby achieving the technical efficacy of fast switching a program desktop and a designated desktop of the handheld apparatus.

### BACKGROUND OF THE INVENTION

1. Field of the Invention

The present invention relates to a switching system and a method thereof, and more particularly to a three-dimensional desktop switching system on a handheld apparatus and a method thereof.

2. Description of Related Art

A handheld apparatus is developed and applied very fast, and is developed from a mobile phone and a personal digital assistant (PDA) at the early stage to a tablet computer and a smartphone, and therefore, the convenience brought by the handheld apparatus is indispensable in daily life of the people.

The handheld apparatus at the early stage is controlled and operated through a key-press manner, but much space is occupied due to the key-press manner, which indirectly limits a display screen of the handheld apparatus.

Up to now, the development of a touch panel technology enables an existing handheld apparatus (for example: a tablet computer and a smartphone) to get rid of the old manner of controlling and operating the handheld apparatus in dependence on key-press, but to control and operate the handheld apparatus through a touch manner. In this way, a wide touch display apparatus (that is, a touch screen) may be used in the handheld apparatus, so that the user may use and operate the handheld apparatus more conveniently.

Because of the progress of the handheld apparatus and the touch technology, a desktop switching function is further provided for the handheld apparatus, so that the user may use the handheld apparatus more conveniently. However, the desktop switching of the existing handheld apparatus is that, the user performs a sliding operation on a touch display apparatus so as to switch one desktop to a next desktop, and when the number of switch desktops provided by the handheld apparatus is too large, too many operations are required for switching from a first desktop to a last desktop, and as whenever one desktop is switched, loading and update of the desktop are required to be performed (for example: a widget in the desktop is synchronized with network information when being loaded), and then a jam and pause phenomenon of the handheld apparatus is caused during desktop switching.

To sum up, it can be known that in the prior art, the problem of too many steps to be operated for the desktop switching of the existing handheld apparatus and a jam and pause phenomenon caused by loading and update of the desktop switching exists for a long time, and therefore, it is necessary to propose improved technical means to solve the problem.

### SUMMARY OF THE INVENTION

In view of the problem of too many steps to be operated for the desktop switching of the existing handheld apparatus and a jam and pause phenomenon caused by loading and update of the desktop switching in the prior art, the present invention discloses a three-dimensional desktop switching system on a handheld apparatus and a method thereof.

The three-dimensional desktop switching system on a handheld apparatus disclosed in the present invention includes: a first receiving module, a display module, a second receiving module, a first switching module, a third receiving module, and a second switching module.

The first receiving module receives a switching instruction; the display module displays a regular polyhedron that each surface of the regular polyhedron is a desktop when the first receiving module receives the switching instruction, wherein at least one desktop is set as a designated desktop, and a plurality of other desktops adjacent to the designated desktop is set as program desktops; the second receiving module receives a program desktop selection instruction when a current display desktop is the designated desktop; the first switching module switches the designated desktop to a selected program desktop according to the program desktop selection instruction when the current display desktop is the designated desktop; the third receiving module receives a designated desktop selection instruction when the current display desktop is one of the program desktops; the second switching module switches the currently displayed program desktop to the designated desktop according to the designated desktop selection instruction when the current display desktop of the handheld apparatus is one of the program desktops.

A three-dimensional desktop switching method on a handheld apparatus disclosed in the present invention includes the following steps.

At first, a regular polyhedron that each surface of the regular polyhedron is a desktop is displayed when a switching instruction is received, wherein at least one desktop is set as a designated desktop, and a plurality of other desktops adjacent to the designated desktop is set as program desktops; then, a program desktop selection instruction is received when a current display desktop is the designated desktop; then, the designated desktop is switched to a selected program desktop according to the program desktop selection instruction when the current display desktop is the designated desktop; then, a designated desktop selection instruction is received when the current display desktop is one of the program desktops; in the end, the currently displayed program desktop is switched to the designated desktop according to the designated desktop selection instruction when the current display desktop is one of the program desktops.

The system and the method disclosed in the present invention are described as above, and the difference between the present invention and the prior art lies in that, in the present invention, the selected program desktop and the selected designated desktop may be switched quick by the program desktop selection instruction and the designated desktop selection instruction, so as to reduce the operating times and the updating times for loading during switching the desktops, for avoiding too many steps to be operated for the desktop switching of the existing handheld apparatus and a jam and pause phenomenon caused by loading and update of the desktop switching.

Through the foregoing technical means, the present invention can achieve the technical efficacy of providing the desktop switching of the handheld apparatus and switching to the designated desktop fast.

### BRIEF DESCRIPTION OF THE DRAWINGS

The invention will become more fully understood from the detailed description given herein below illustration only, and thus is not limitative of the present invention, and wherein:

FIG. 1 is a block diagram of a three-dimensional desktop switching system on a handheld apparatus in the present invention.

FIG. 2 is a flow chart of a three-dimensional desktop switching system on a handheld apparatus in the present invention.

FIG. 3 is a schematic diagram of a three-dimensional switching user interface for a desktop on a handheld apparatus in the present invention.

FIG. 4A is a schematic diagram of a three-dimensional desktop for a desktop on a handheld apparatus in the present invention.

FIG. 4B is a schematic diagram of a switching result of a designated desktop selection instruction for a desktop on a handheld apparatus in the present invention.

FIG. 4C is a schematic diagram of a switching result of a program desktop selection instruction for a desktop on a handheld apparatus in the present invention.

FIG. 4D is a schematic diagram of a three-dimensional switching result for a desktop on a handheld apparatus in the present invention.

### DESCRIPTION OF THE EMBODIMENTS

Implementation manners of the present invention are illustrated in detail below with reference to accompanying drawings and embodiments, so the implementation procedure about how technical means is applied to the present invention to solve the technical problem and achieve the technical efficacy can be fully understood and implemented accordingly.

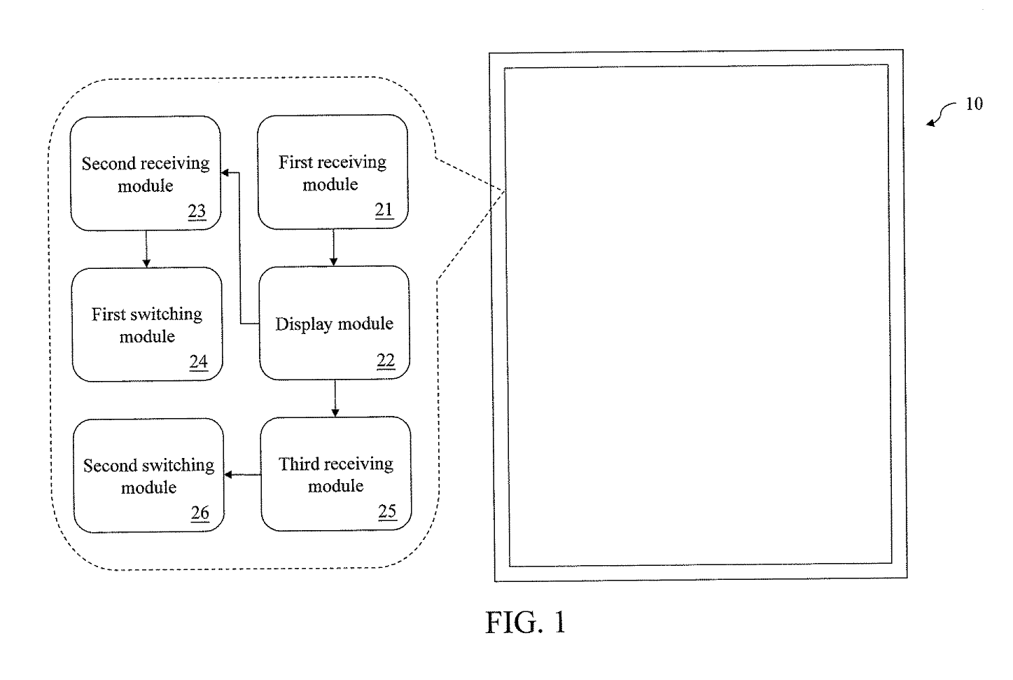

A three-dimensional desktop switching system on a handheld apparatus disclosed in the present invention is described in the following first, and referring to FIG. 1, FIG. 1 is a block diagram of a three-dimensional desktop switching system on a handheld apparatus in the present invention.

The three-dimensional desktop switching system on a handheld apparatus disclosed in the present invention includes: a first receiving module 21, a display module 22, a second receiving module 23, a first switching module 24, a third receiving module 25, and a second switching module 26.

When a user switch a desktop of a handheld apparatus 10, the user may press a switching key in a touch display apparatus of the handheld apparatus 10, or the user performs a designated operation on the touch display apparatus of the handheld apparatus 10 so as to swipe a switching instruction, and then the first receiving module 21 receives the switching instruction. This is only used as an example for illustration herein, but not intended to limit the application scope of the present invention.

When the first receiving module 21 receives the switching instruction, the display module 22 displays a regular polyhedron that each surface of the regular polyhedron is a desktop, wherein at least one desktop is set as a designated desktop, and a plurality of other desktops adjacent to the designated desktop is set as program desktops: when the regular polyhedron is regular tetrahedron, one surface of a regular tetrahedron is set as a designated desktop; when the regular polyhedron is regular hexahedron, a pair of symmetric surfaces of a regular hexahedron is set as designated desktops respectively; and when the regular polyhedron is regular dodecahedron, a pair of symmetric surfaces of a regular dodecahedron is set as designated desktops respectively.

After the display module 22 displays a regular polyhedron that each surface of the regular polyhedron is a desktop, and when a current display desktop of the handheld apparatus 10 is the designated desktop, the second receiving module 23 may receive the program desktop selection instruction and swipe left, right, up and down to operate from the current display to the program desktop (this is only used as an example for illustration herein, but not intended to limit the application scope of the present invention).

When the second receiving module 23 receives the program desktop selection instruction, the first switching module 24 may switch the designated desktop to a selected program desktop according to the program desktop selection instruction.

Specifically, a bottom surface of a regular tetrahedron is set as the designated desktop, and a plurality of other desktops adjacent to the designated desktop is set as program desktops, that is, the plurality of other desktops is set as a first desktop, a second desktop, and a third desktop respectively. It is assumed that when a current display desktop of the handheld apparatus 10 is the designated desktop, the second receiving module 23 receives a selecting the first desktop instruction by swiping a program desktop selection instruction on the touch display apparatus of the handheld apparatus 10, and the first switching module 24 may switch the designated desktop to the first desktop according to the program desktop selection instruction being “selecting the first desktop”.

A top desktop of a regular hexahedron is set as a first designated desktop, a bottom desktop thereof is set as a second designated desktop (the top desktop and the bottom desktop are symmetric desktops), and a plurality of other desktops adjacent to the first designated desktop and the second designated desktop is set as program desktops, that is, the plurality of other desktops is set as a first desktop, a second desktop, a third desktop, and a fourth desktop respectively. When a current display desktop of the handheld apparatus 10 is the first designated desktop, the second receiving module 23 receives a selecting the second desktop by swiping a program desktop selection instruction on the touch display apparatus of the handheld apparatus 10, and the first switching module 24 may switch the first designated desktop to the second desktop according to the program desktop selection instruction being “selecting the second desktop”.

A top desktop of a regular dodecahedron is set as a first designated desktop, a bottom desktop thereof is set as a second designated desktop (the top desktop and the bottom desktop are symmetric desktops), and a plurality of other desktops adjacent to the designated desktops is set as program desktops, that is, the plurality of other desktops is set as a first desktop, a second desktop, a third desktop, a fourth desktop, a fifth desktop, a sixth desktop, a seventh desktop, an eighth desktop, a ninth desktop, and a tenth desktop. When a current display desktop of the handheld apparatus 10 is the first designated desktop, the second receiving module 23 receives a selecting the third desktop by swiping a program desktop selection instruction on the touch display apparatus of the handheld apparatus 10, and the first switching module 24 may switch the first designated desktop to the third desktop according to the program desktop selection instruction being “selecting the third desktop”.

After the display module 22 displays a regular polyhedron that each surface of the regular polyhedron is a desktop, and when a current display desktop of the handheld apparatus 10 is the program desktop, the third receiving module 25 may receive the designated desktop selection instruction twice continuously, wherein the designated desktop selection instruction is swiped left, right, up and down to operate from the current display to the program desktop on the touch display apparatus of the handheld apparatus 10 (this is only used as an example for illustration herein, but not intended to limit the application scope of the present invention).

When the third receiving module 25 receives the designated desktop selection instruction, the second switching module 26 may switch a currently displayed program desktop to the designated desktop according to the designated desktop selection instruction.

Specifically, a bottom surface of a regular tetrahedron is set as the designated desktop, and a plurality of other desktops adjacent to the designated desktop is set as program desktops, that is, the plurality of other desktops is set as a first desktop, a second desktop, and a third desktop respectively. When a current display desktop of the handheld apparatus 10 is the first desktop, the third receiving module 25 receives a selecting the designated desktop by swiping a designated desktop selection instruction on the touch display apparatus of the handheld apparatus 10, and the second switching module 26 may switch the first desktop to the designated desktop according to the designated desktop selection instruction being “selecting the designated desktop”.

A top desktop of a regular hexahedron is set as a first designated desktop, a bottom desktop thereof is set as a second designated desktop (the top desktop and the bottom desktop are symmetric desktops), and a plurality of other desktops adjacent to the first designated desktop and the second designated desktop is set as program desktops, that is, the plurality of other desktops is set as a first desktop, a second desktop, a third desktop, and a fourth desktop respectively. When a current display desktop of the handheld apparatus 10 is the second desktop, the third receiving module 25 receives a selecting the designated desktop by swiping on the touch display apparatus of the handheld apparatus 10a designated desktop selection instruction, and the second switching module 26 may switch the second desktop to the second designated desktop according to the designated desktop selection instruction being “selecting the second designated desktop”.

A top desktop of a regular dodecahedron is set as a first designated desktop, a bottom desktop thereof is a second designated desktop (the top desktop and the bottom desktop are symmetric desktops), and a plurality of other desktops adjacent to the designated desktops is set as program desktops, that is, the plurality of other desktops is set as a first desktop, a second desktop, a third desktop, a fourth desktop, a fifth desktop, a sixth desktop, a seventh desktop, an eighth desktop, a ninth desktop, and a tenth desktop respectively. When a current display desktop of the handheld apparatus 10 is the third desktop, the third receiving module 25 receives a selecting the second designated desktop on the touch display apparatus of the handheld apparatus 10, and the second switching module 26 may switch the third desktop to the second designated desktop according to the designated desktop selection instruction being “selecting the second designated desktop”.

The user may perform a double click operation on the touch display apparatus of the handheld apparatus 10 (this is only used as an example for illustration herein, but not intended to limit the application scope of the present invention), so as to select one switched desktop of the N desktops as the designated desktop.

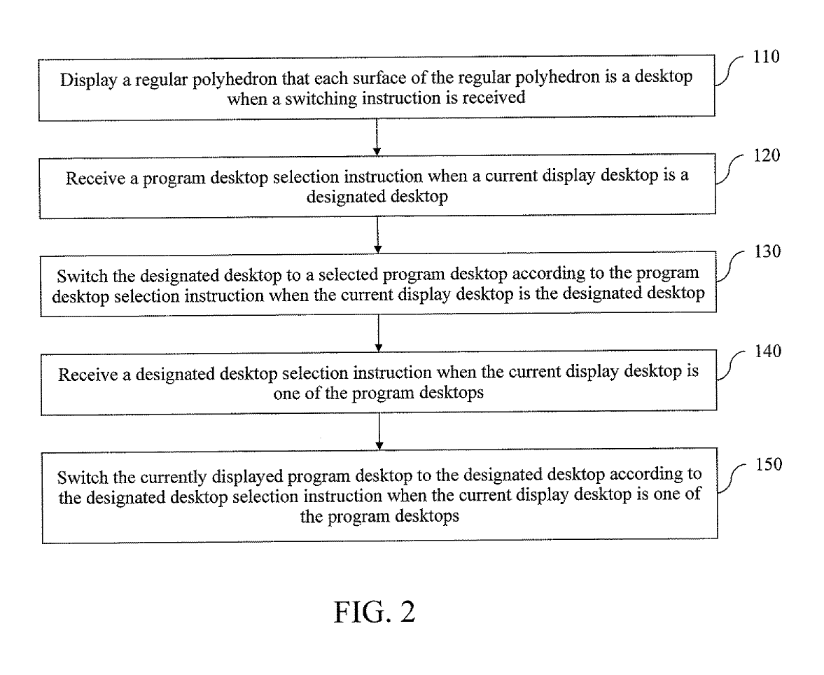

Then, an operation manner and a flow of the present invention are illustrated with an actual example below, following embodiments are described in synchronous coordination with FIG. 1 and FIG. 2, and FIG. 2 is a flow chart of a three-dimensional desktop switching method on a handheld apparatus in the present invention.

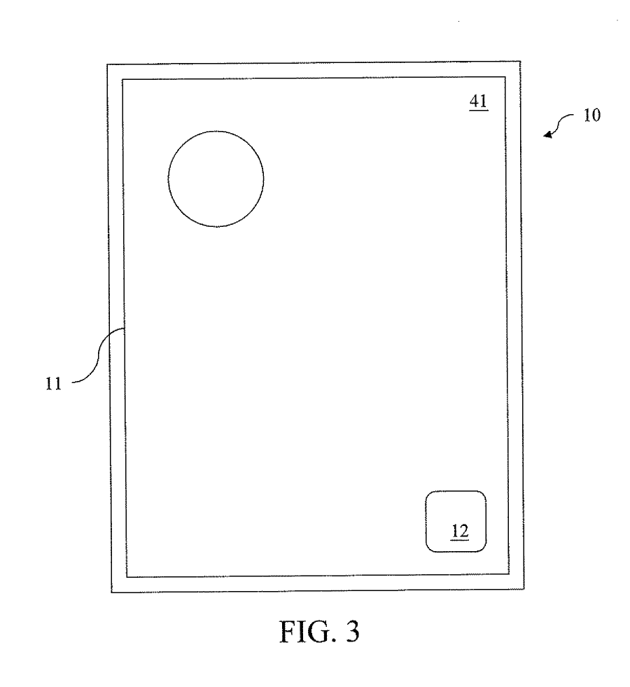

At first, referring to FIG. 3, FIG. 3 is a schematic diagram of a three-dimensional switching user interface for a desktop on a handheld apparatus in the present invention.

When the user switch the desktop of the handheld apparatus 10, the user may press a switching key 12 in a touch display apparatus 11 of the handheld apparatus 10 to swipe the switching instruction, and the first receiving module 21 receives the switching instruction (step 110).

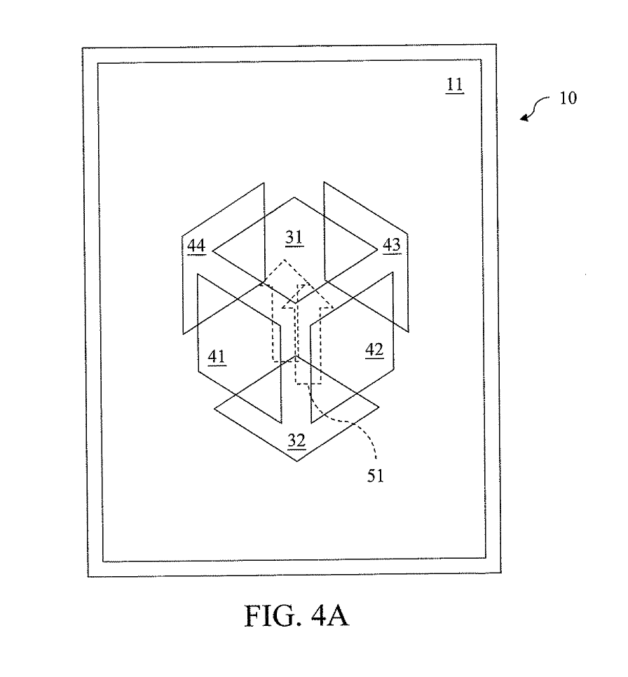

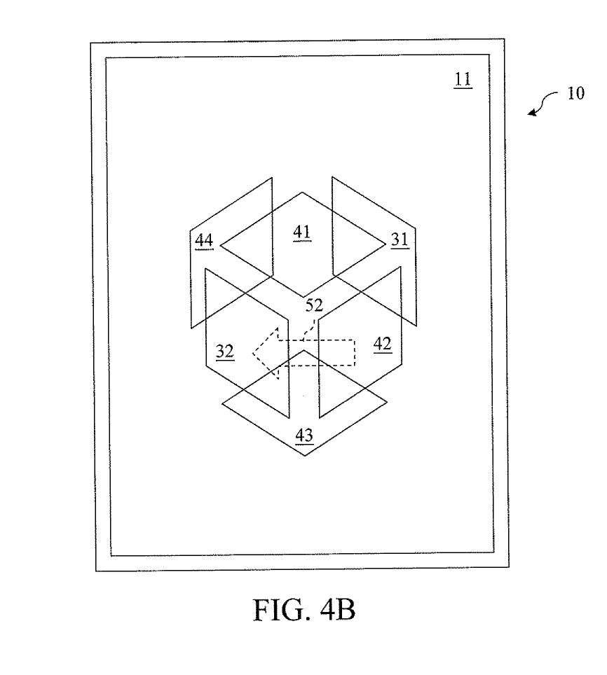

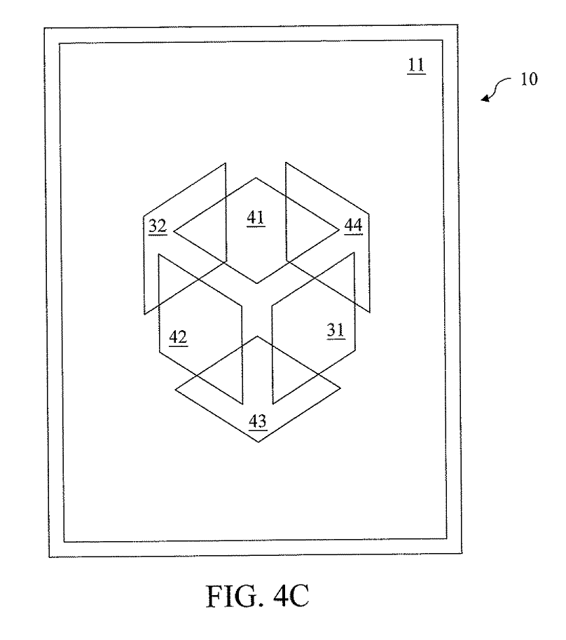

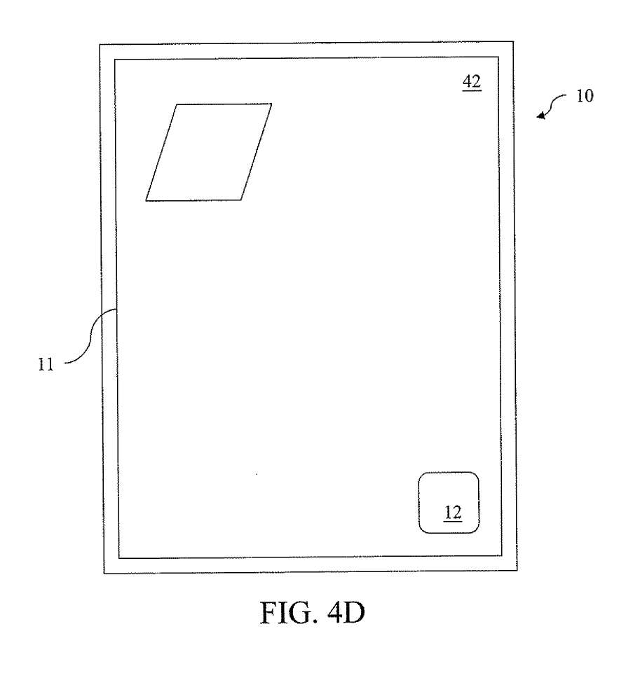

Then, referring to FIG. 4A, FIG. 4A is a schematic diagram of a three-dimensional desktop for a desktop on a handheld apparatus in the present invention.

When the first receiving module 21 receives the switching instruction, the display module 22 displays a regular hexahedron that each surface of the regular hexahedron is a desktop (this is only used as an example for illustration herein, but not intended to limit the application scope of the present invention, step 110). A top desktop of the regular hexahedron is set as a first designated desktop 31, a bottom desktop thereof is set as a second designated desktop 32 (the first designated desktop 31 and the second designated desktop 32 are symmetric desktops), and a plurality of other desktops adjacent to the first designated desktop 31 and the second designated desktop 32 is set as program desktops, that is, the plurality of other desktops is set as a first desktop 41, a second desktop 42, a third desktop 43, and a fourth desktop 44 respectively.

As far as the embodiment is concerned, a current display desktop of the handheld apparatus 10 is a first desktop 41 (that is, a program desktop), and the user performs a sliding operation 51 on the touch display apparatus of the handheld apparatus 10 (which is represented in FIG. 4A with a dashed line) so as to trigger a designated desktop selection instruction being “selecting the second designated desktop”, which is received by the third receiving module 25 (step 140), and the second switching module 26 may switch the first desktop 41 to the second designated desktop 32 according to the designated desktop selection instruction being “selecting the second designated desktop” (step 150). For the switching result of the designated desktop selection instruction, reference is made to FIG. 4B, and FIG. 4B is a schematic diagram of a switching result of a designated desktop selection instruction for a desktop on a handheld apparatus in the present invention.

When a current display desktop of the handheld apparatus 10 is a second designated desktop 32 (that is, a designated desktop), and the user performs a sliding operation 52 on the touch display apparatus of the handheld apparatus 10 (which is represented in FIG. 4B with a dashed line) so as to trigger a program desktop selection instruction being “selecting the second desktop”, which is received by the second receiving module 23 (step 120), and the first switching module 24 may switch the second designated desktop 32 to the second desktop 42 according to the program desktop selection instruction being “selecting the second desktop” (step 130). For the switching result of the program desktop selection instruction, reference is made to FIG. 4C, and FIG. 4C is a schematic diagram of a switching result of a program desktop selection instruction for a desktop on a handheld apparatus in the present invention.

Then, the user performs a double click operation on a touch display apparatus 11 of the handheld apparatus 10 (this is only used as an example for illustration herein, but not intended to limit the application scope of the present invention), so as to select the switched second desktop 42, and the user may switch the desktop of the handheld apparatus 10 from the first desktop 41 to the second desktop 42. For the result of the switching, reference is made to FIG. 4D, and FIG. 4D is a schematic diagram of a three-dimensional switching result for a desktop on a handheld apparatus in the present invention.

To sum up, it can be known that the difference between the present invention and the prior art lies in that, in the present invention, the selected program desktop and the selected designated desktop may be switched quickly by the program desktop selection instruction and the designated desktop selection instruction, so as to reduce the operating times and the updating times for loading during switching the desktops, for avoiding too many steps to be operated for the desktop switching of the existing handheld apparatus and a jam and pause phenomenon caused by loading and update of the desktop switching.

With the technical means, the problem of too many steps to be operated for the desktop switching of the existing handheld apparatus and a jam and pause phenomenon caused by loading and update of the desktop switching in the prior art may be solved, and the technical efficacy of providing the desktop switching of the handheld apparatus and switching to the designated desktop fast may further be achieved.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A three-dimensional desktop switching system on a handheld apparatus, comprising:
a first receiving module, receiving a switching instruction;
a display module, displaying a regular polyhedron that each surface of the regular polyhedron is a desktop when the first receiving module receives the switching instruction, wherein at least one desktop is set as a designated desktop, and a plurality of other desktops adjacent to the designated desktop is set as program desktops;
a second receiving module, receiving a program desktop selection instruction when a current display desktop is the designated desktop;
a first switching module, switching the designated desktop to a selected program desktop according to the program desktop selection instruction when the current display desktop is the designated desktop;
a third receiving module, receiving a designated desktop selection instruction when the current display desktop is one of the program desktops; and
a second switching module, switching the currently displayed program desktop to the designated desktop according to the designated desktop selection instruction when the current display desktop is one of the program desktops.

2. The three-dimensional desktop switching system on a handheld apparatus according to claim 1, wherein when the regular polyhedron is regular tetrahedron, one surface of a regular tetrahedron is set as a designated desktop.

3. The three-dimensional desktop switching system on a handheld apparatus according to claim 1, wherein when the regular polyhedron is regular hexahedron, a pair of symmetric surfaces of a regular hexahedron is set as designated desktops.

4. The three-dimensional desktop switching system on a handheld apparatus according to claim 1, wherein when the regular polyhedron is regular dodecahedron, a pair of symmetric surfaces of a regular dodecahedron is set as designated desktops.

5. The three-dimensional desktop switching system on a handheld apparatus according to claim 3, wherein the symmetric desktops are same designated desktops or different designated desktops.

6. The three-dimensional desktop switching system on a handheld apparatus according to claim 4, wherein the symmetric desktops are same designated desktops or different designated desktops.

7. A three-dimensional desktop switching method on a handheld apparatus, comprising:
displaying a regular polyhedron that each surface of the regular polyhedron is a desktop when a switching instruction is received, wherein at least one desktop is set as a designated desktop, and a plurality of other desktops adjacent to the designated desktop is set as program desktops;
receiving a program desktop selection instruction when a current display desktop is the designated desktop;
switching the designated desktop to a selected program desktop according to the program desktop selection instruction when the current display desktop is the designated desktop;
receiving a designated desktop selection instruction when the current display desktop is one of the program desktops; and
switching the currently displayed program desktop to the designated desktop according to the designated desktop selection instruction when the current display desktop is one of the program desktops.

8. The three-dimensional desktop switching method on a handheld apparatus according to claim 7, wherein in the step of displaying a regular polyhedron that each surface of the regular polyhedron is the desktop when a switching instruction is received, wherein at least one desktop is set as a designated desktop, and a plurality of other desktops adjacent to the designated desktop is set as program desktops, when the regular polyhedron is regular tetrahedron, one surface of a regular tetrahedron is set as a designated desktop.

9. The three-dimensional desktop switching method on a handheld apparatus according to claim 7, wherein in the step of displaying a regular polyhedron that each surface of the regular polyhedron is the desktop when a switching instruction is received, wherein at least one desktop is set as a designated desktop, and a plurality of other desktops adjacent to the designated desktop is set as program desktops, when the regular polyhedron is regular hexahedron, a pair of symmetric surfaces of a regular hexahedron is set as designated desktops respectively.

10. The three-dimensional desktop switching method on a handheld apparatus according to claim 7, wherein in the step of displaying a regular polyhedron that each surface of the regular polyhedron is the desktop when a switching instruction is received, wherein at least one desktop is set as a designated desktop, and a plurality of other desktops adjacent to the designated desktop is set as program desktops, when the regular polyhedron is regular dodecahedron, a pair of symmetric surfaces of a regular dodecahedron is set as designated desktops respectively.

11. The three-dimensional desktop switching method on a handheld apparatus according to claim 9, wherein the symmetric desktops are same designated desktops or different designated desktops.

12. The three-dimensional desktop switching method on a handheld apparatus according to claim 10, wherein the symmetric desktops are same designated desktops or different designated desktops.
